(19) United States
(12) Patent Application Publication
(10) Pub. No.: US 2010/0312583 A1
(43) Pub. Date: Dec. 9, 2010

(54) SYSTEM AND METHOD FOR COST EFFECTIVELY FUNDING A LOAN

(76) Inventor: Douglas Monticciolo, Monticello, NJ (US)

Correspondence Address: STROOCK & STROOCK & LAVAN LLP, 180 MAIDEN LANE, NEW YORK, NY, 10038, US

(21) Appl. No.: 12/651,977

(22) Filed: Jan. 4, 2010

Related U.S. Application Data
(63) Continuation of application No. 09/805,522, filed on Mar. 13, 2001, now abandoned.
(60) Provisional application No. 60/188,729, filed on Mar. 13, 2000.

(51) Int. Cl. G06Q 40/00; G06Q 90/00

(52) U.S. Cl. 705/4; 705/500

(57) ABSTRACT

A method of achieving cost effective funding by providing a financial guaranty in the form of reinsurance to an insurance company to insure the lender's or a third party's loans. The financial guaranty enables the lender (i.e., the originator of the loan) or a third party to retain a first loss on a pool of assets such as, for example, a pool of loans underwritten by the lender or third party. The financial guaranty preferably provides sufficient coverage for loan losses that may occur due default of a loan or a pool of loans and induces an insurer to issue the insurance.

### CROSS-REFERENCE TO RELATED APPLICATION

This patent application is a continuation of U.S. patent application Ser. No. 09/805,522, filed Mar. 13, 2001, entitled “A METHOD OF COST EFFECTIVELY FUNDING A LOAN,” which claims priority from provisional patent application No. 60/188,729, filed on Mar. 13, 2000, both of which are hereby incorporated herein by reference.

### BACKGROUND OF THE INVENTION

1. Field of the Invention

The present invention is directed to a method of cost effectively funding a loan.

2. Description of Related Art

The Internet has simplified many commercial transactions, such as shopping, making travel reservations, trading stocks, and others. The Internet also makes it possible to shop for a loan twenty-four hours a day, seven days a week, with relative ease. Web-sites exist that enable a loan consumer (also referred to herein as a borrower) to enter certain information via a web-page such as, for example, certain personal and financial data, and to simultaneously solicit loan quotes from a plurality of lending institutions (also referred to herein as lenders). That aspect of on-line loan origination is clearly an advantage to the traditional model in which the borrower must separately solicit quotes from the various lending institutions by filling out and submitting the various loan request forms to each of the separate lenders.

In the on-line model described above, responses from the various lending institutions are presented to the borrower as offers which the borrower may accept or reject. If an offer is accepted, the borrower and lending institution revert to a more traditional loan process in which various forms and supporting documentation are required from the borrower.

Underwriting and funding of such on-line loan transactions also follows traditional models, with the lending institution typically mitigating its risk by conducting due diligence on the borrower, taking a security interest in collateral (e.g., real estate, equipment, financial assets, etc.), and through diversification by spreading the risk of loss (such as may occur when a borrower defaults) over numerous loans. The lender may also obtain insurance from a financial guarantor (i.e., an insurance company) for a loan or a pool of loans to mitigate the risk of loss for the lender or other provider of the loan proceeds (e.g., investors).

While this method and system for underwriting loans has traditionally worked, it has its shortcomings. For example, if a lender does not have an adequate credit rating it may be difficult for the lender to obtain insurance from an insurance company, and thus the lender will not be able to access the capital markets. Such a lender would likely have to accumulate a significant amount of product (i.e., loans) and securitize the accumulated product as a fixed pool of assets that may be purchased or invested in by investors. Such a lender also would not likely have access to capital markets as a source of funding for its loans.

### SUMMARY OF THE INVENTION

The present invention overcomes the above-described shortcomings of the prior art. In accordance with embodiments of the present invention, a lender provides a financial guaranty in the form of reinsurance or other like protection to the insurance company as first loss protection and to insure the lender's loans. The reinsurance or other like protection enables a lender to obtain insurance from a rated insurance company. As a result, the lender's loans derive the benefit of the insurance company's rating, and an unrated or inadequately rated lender may obtain a rated pool of assets that is attractive to investors in the capital markets. The financial guaranty thus enables the lender to receive attractive funding through the private placement and capital markets (e.g., through the issuance of commercial paper). The financial guaranty enables the lender (i.e., the originator of the loan) to retain a first loss on a pool of assets such as, for example, a pool of loans underwritten by the lender. The financial guaranty preferably provides sufficient coverage for loan losses that may occur due to default of a loan or a pool of loans.

In an embodiment of the present invention, a lender may originate one or more loans (of virtually any type) to one or more borrowers (of virtually any type). To obtain adequately rated insurance for the one or more loans, the lender may provide first loss protection in the form of reinsurance to the insurance company to minimize the insurance company's exposure due to loan default. By the lender or another entity providing first loss protection for the one or more loans, the insurance company may be enticed to insure the lender's loans. The lender may thus obtain rated insurance for its loan(s) and gain access to the capital markets as a source of funding for its loan(s).

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference numerals depict like elements throughout the several views:

FIG. 1 is a schematic block diagram depicting the relationship between and among the various parties to a loan in accordance with the present invention; and

FIG. 2 is a schematic block diagram of a lender and borrower communicating over a network in accordance with the present invention.

### DETAILED DESCRIPTION OF THE PREFERRED EMBODIMENTS

The present invention is directed to a method of cost effectively funding a loan. In accordance with embodiments of the present invention, a novel form of funding commercial loans is provided whereby the lender provides reinsurance or other like protection to an insurer of the lender's loans as first loss protection for the loans originated by the lender. Provision of reinsurance by the lender induces the insurer to issue the insurance.

The inventive method may be carried out in connection with a computer connectable to a network such as, for example, LAN, WAN, intranet, Internet (including the World-Wide Web), cellular, etc.

More specifically, embodiments may be implemented on a lender's computer operable in connection with computer readable program code residing on a computer readable medium (e.g., software, firmware, etc.), which may be an electronic memory internal to the lender's computer (e.g., a hard disk, RAM, ROM, etc.) or an external storage device (e.g., CD ROM, DVD, flash drive, etc.) or available from a remote storage device via an electronic network. A computer readable medium in accordance with one embodiment of the present invention may be programmed to include one or more programming modules or routines designed and configured, and executable on a computer (as further defined below), to cause any of the various functions, processes, and steps related to the method of cost effectively funding a loan (e.g., analyzing credit risk or processing loan applications) to be performed by the lender's computer. The lender's computer is also capable of electronically communicating with a borrower having a computer, via the borrower's computer, to carry out the functions, steps, or processes required to implement the process described herein.

In accordance with a certain embodiments of the present invention, the borrower's computer and the lender's computer may assume a client-server relationship wherein the relevant programming modules, routines, or protocols (e.g., those needed to store borrower information or process a loan application) may be provided on the lender's computer (e.g., server) and is downloaded to or accessed by the borrower's computer (client) to receive and/or process data regarding a loan (e.g., borrower information). In alternate embodiments, these software modules or routines may be electronically distributed to borrowers (e.g., via e-mail or downloaded via an FTP site). In other embodiments, the lender or the lender's computer may send the borrower computer readable media, such as a flash drive or a CD, containing the relevant software modules, routines, or protocols, which may be loaded onto and executed on the borrower's computer.

As used herein, the term “computer” is intended to be construed broadly, and in a non-limiting manner, and to include, without limitation and by way of illustration only, any electronic device capable of receiving input, processing, storing and providing output, typically as digital data. A computer may be a computer of any style, size, and configuration including, without limitation, a server, workstation, desktop, laptop, Internet appliance, notebook, personal digital assistant (PDA), etc. A computer typically includes the following components: a central processing unit (CPU or processor) operable in connection with software, permanent memory (e.g., hard-disk drive, ROM), temporary memory (e.g., RAM), an input device (e.g., keyboard, mouse, trackball, etc.), an output device (e.g., display), and I/O device (e.g., modem). It is known to persons skilled in the art that a computer may comprise some or all of those components, in addition to components not listed.

A “borrower”, as the term is used herein, may be any type of borrower including, by way of non-limiting example, an individual, small business, or any entity desiring to borrow money for whatever reason. Similarly, a “lender”, as the temi is used herein, may be any entity in the business of loaning money. In addition, the term “loan” is not intended to refer to a particular type of loan, and is thus used herein in a broad, non-limiting manner and is intended to be interpreted in that way. Those terms (and others) are intended to be interpreted broadly herein, and are not intended to define or otherwise limit the scope of the present invention.

As will be understood by those skilled in the art, the terms “borrower” and “lender” may also refer to the computers operated by such respective individuals and/or entities to implement the method steps described herein.

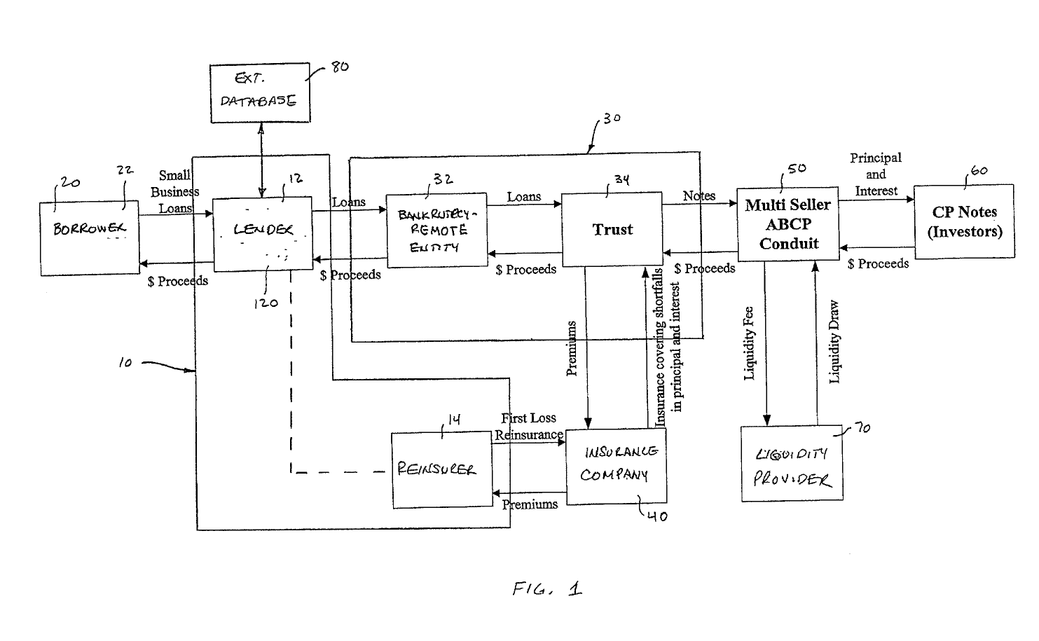

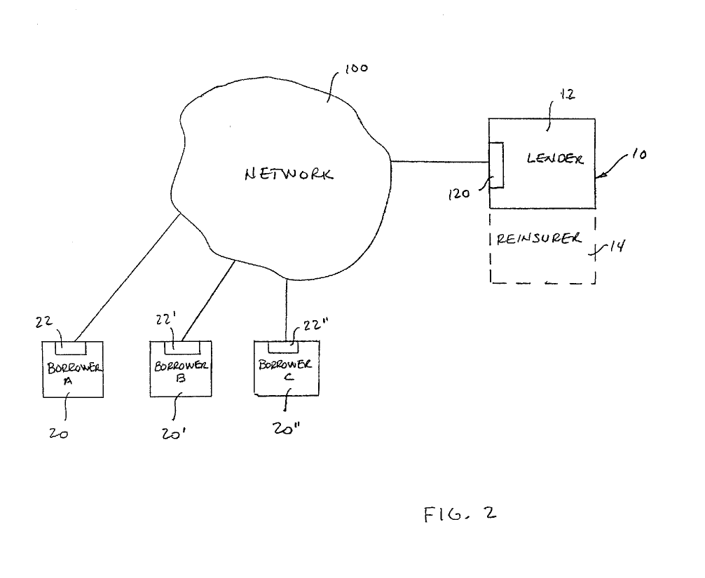

Referring now to the drawings, FIG. 1 depicts the relationship between and among the various parties to a loan origination, funding, maintenance and insurance, and FIG. 2 is a schematic block diagram of a lender and borrower communicating over a network in accordance with the present invention. While the present invention and the description thereof provided herein preferably utilizes computers connectable to a network (i.e., on-line loan transactions), the present invention may also utilize more traditional means of loan origination such as in person processing, telephonic processing, or the like.

With continued reference to FIGS. 1 and 2, the loan process, as described herein, typically begins (originates) when a borrower 20 having a computer 22 connectable to a network 100 requests a loan quotation from a lending institution 10 having a computer 120 connectable to the network 100. The lending institution 10 may comprise a lender 12 and a reinsurer 14. While the lender 12 and reinsurer 14 are disclosed herein as both being part of the lending institution 10, they may also comprise separate entities. The lending process may alternatively begin when a lender 12 makes a loan offer to a borrower 20. During that origination process, the borrower 20 may indicate certain desired features of the loan such as, for example, term, points payable at closing, loan amount, and type of loan. The lender 12 may also dictate similar features of the loan as well as interest rate. In addition, the lender 12 typically requires that the borrower 20 provide certain personal and financial information to enable the lender 12 to evaluate the credit worthiness (i.e., the credit risk) of the borrower 20. All of the above-described information, and other information known to a person of skill in the art, may be communicated between the lender 12 and borrower 20 via computers (each of the lender 12 and borrower 20 having a computer as depicted in FIG. 2), via the telephone, in-person, or any combination of the foregoing. In a preferred embodiment, the lender 12 and borrower 20, using a computer 22, will access a website provided by the lender's computer 120 (or provided on a computer (server) maintained for or on behalf of the lender 12), fill in certain on-line forms, and transmit the information provided via the on-line forms to the lender's computer 120. For example, the lender 12 may require the borrower's age, tax identification number, social security number of the majority shareholder of a company (this example being given by way of small business loans), the loan size, and the industry. Other information may be requested of the borrower 20, as a routine matter of design choice, it being obvious to persons skilled in the art and from the disclosure provided herein the credit risk of any particular borrower 20 may only be sufficiently determined if certain information is provided by the borrower 20 to the lender 12. Moreover, a lender 12 may be required (by its insurer, a regulatory agency, or other third party) to elicit certain information prior to approving a loan. In any case, the information provided by the borrower 20 is communicated from the borrower 20 (the borrower's computer 22) to the lender's computer 120 over the network 100. Preferably, software provided on the lender's computer 120 confirms the veracity of the information received from the borrower 20 and obtains further information about borrower 20 from external databases 80 such as credit bureaus, judgment rolls of various courts and the like. Lender 12 (i.e., lender's computer 120) may compare the various information obtained about the borrower 20 with certain predetermined criteria. That analysis provides an initial determination as to the amount of risk associated with the loan. If the result of the analysis falls out of bounds of the predetermined criteria, then the risk may be too great and lender 12 will send a rejection response to borrower 20 or may refer borrower 20 to another lender.

The lender's computer 120 preferably includes a processor and software operable in connection therewith for, by way of example and not limitation, receiving information from the borrower 20 for a loan request, determining a credit risk of the borrower 20 from the information received, and approving or rejecting the loan request based on the determined credit risk.

If the risk is determined to be within the predetermined criteria, then borrower 20 may be given a contingent approval by telephone, over the Internet by way of e-mail, by an indication at the website of lender 12 or by regular mail or overnight courier.

Once the borrower 20 has selected a loan and the loan has been approved by the lender 12, lender 12 then conducts a more in-depth due diligence by first providing an application to borrower 20. Again, this can be done on-line or by mail, or in person. In this example, in which an application is provided on-line and automatically filled out with all information previously filled out by borrower or gathered from external databases 80, the application itself may be keyed to the particular industry and loan program selected. Borrower 20 can then either download the application and print the application out to fill out manually and then submit to lender 12, or borrower 20 can fill out the application on-line. The application will include more detailed request for assets, potential collateral for the loan, questions about the particular company for which the loan will be granted and the like. Once completed, the application is transmitted either on-line, by e-mail, in person, by a surrogate such as a lawyer or an accountant, by facsimile, by mail, by phone or by overnight courier.

Lender 12 then again confirms the accuracy of the information provided in the application by checking external databases 80, for example. If there is a discrepancy, the application may be returned with a question regarding the discrepancy in real time on-line to borrower 20. It should be noted that the depth of due diligence is a function of the loan program. As a matter of necessity, the shorter the closing date of a particular loan program, the less depth is provided for the due diligence and therefore a higher interest rate is usually applied. Accordingly, the longer the closing period, the more due diligence can be conducted which potentially reduces the risk of the loan and lowers the interest rate.

In a preferred embodiment, the due diligence investigation may include, by way of non-limiting example: bank and trade references; customer and other investigations; lien and litigation searches; product and market surveys; appraisals of assets when taken as collateral security; financial statement analysis to include an assessment of financial condition, profit or loss, cash flow, debt service ability, asset quality, working capital adequacy, and off-balance sheet exposure and other liabilities listed in the footnotes; financial projections analysis; any analyst recommendation; identification of repayment sources; strengths and weaknesses; an analysis of the borrower's industry and management; where applicable, guarantor analysis to include evaluation of contingent debt and other off-balance sheet items; documentation and exception report overviews; and a summary of any lender management and/or site visit.

Once the lender 12 and borrower 20 have come to terms regarding all aspects of the loan, the lender 12 may provide the proceeds of the loan to the borrower 20 via a warehouse line of credit, for example, or alternatively, a third party may provide the proceeds to the lender 12 for pass-through to the borrower 20 or through certificates of deposit and/or Federal Home Loan Bank advances. It is also possible for a lender 12 to purchase an existing loan or pool of loans, using and benefiting from the funding methodology described herein.

It is also possible that a lender 12 not be rated and its loans not be rated making it difficult and expensive to secure investors and insurance. In accordance with the present invention, the lender 12 transfers its loan (the term “loan” also referring to a pool of loans) to an entity 30 comprised of a bankruptcy-remote entity 32 (such an entity being known to persons of skill in the art and being established by following certain requirements and satisfying certain criteria regarding the entity structure) and a trust 34. In that way, the loan is now shielded from the creditors of the lender 12, and becomes a more desirable financial instrument for potential investors.

The bankruptcy-remote entity 32 may pledge or sell the loan to the trust 34 which may be a bank, trust company, or the like, and which holds the loan assets on behalf of and issues notes to investors 60 (discussed in more detail below), collects proceeds from investors 60 and passes them through to the lender 12 (via the bankruptcy-remote entity 32), and obtains insurance on a note issued by the trust 34 to an asset-based commercial paper (ABCP) conduit 50, for example. The ABCP conduit 50 may be a bank or other financial institution that issues commercial paper, notes or other debt instruments to investors 60 (e.g., mutual funds). For example, the note is sold to the ABCP conduit 50 that issues commercial paper to investors 60 in order to fund the loans. Through this process, the lender is able to achieve a more cost effective source of funds for each loan. The trust 34 will pay a premium on outstanding loan amounts to a financial guarantor 40 (e.g., an insurance company or insurer) for the insurance on the note.

A liquidity provider 70 covers any discontinuity of payments from the borrower 20 to the ABCP portal 50.

A reinsurer 14, which may be affiliated with the lender 12 (i.e., part of the lending institution 10), or may be a third party, provides first loss reinsurance protection to the insurer 40 for losses on a predetermined percentage of total loans originated for a predetermined period. As used herein, the term “first loss protection” refers to the reinsurer 14 satisfying any payment obligations (up to a predetermined amount) caused by or as a result of borrower default. For example, the reinsurer 14 may provide first loss reinsurance for losses on 2% of the total loan amount originated for each year until the loan pool matures. The insurer 40 will pay the reinsurer 14 a predetermined amount on outstanding loans per annum for the reinsurance protection. Both the insurance and reinsurance policies will remain in force for the entire life of the loan pool. In a preferred embodiment, the reinsurer 14 is the lender 12, an affiliate of the lender 12, or otherwise associated with the lender in some manner. Thus, the present invention provides a novel form of funding commercial loans by providing, by the lender, reinsurance as a first loss position for the loans originated by the lender and assuring that the lender will have access to more cost effective funding.

In the case where the reinsurer 14 is part of the lending institution 10, the reinsurer may provide reinsurance for the lender's loans, and/or for a third party's loans.

As discussed above, loans are only accepted based upon a complete due diligence of potential borrowers as matched against loan programs and as performed by the lender 12. The insurer 40 may utilize the same due diligence or provide its own criteria to determine the risk allotted with each loan and set premiums accordingly. In a preferred embodiment, the insurer 40 may access a database maintained on the lender's computer 120; the database having stored therein all pertinent information about borrowers and loans. The insurer 40 may thus monitor the activities of the lender 12. Since the insurer 40 is rated, the notes it insures are also rated (i.e., the insurer's rating inures to the benefit of the notes it insures). Thus, what began as an unrated loan by an unrated lender 12 has become a rated note and a desirable investment instrument.

As discussed, it is to be understood that, in certain embodiments, any one or more of these aforementioned steps, procedures, and analyses may be implemented on one or more computers connected to a network operable in connection with computer readable program code or computer readable medium. For example, according to the programs stored on the computer readable medium and executed by the lender's computer, among other related processes, borrower information is electronically received by the lender's computer via an electronic communication link (e.g., network) from a borrower's computer and verified against external data electronically requested and received or retrieved from external databases, the credit risk of a borrower is determined by the lender's computer based on predetermined criteria, and the loan request of the borrower is accepted or rejected, at least in some instances, by the lender's computer electronically communicating via an electronic communication link the acceptance/rejection to the borrower's computer and/or updating a database to record the acceptance/rejection.

The insurer 40 will charge premiums to the trust 34 and issue an insurance policy for a potential block of loans; although the pricing may be in terms specific to each loan. The premium to be paid is based on each loan. There may be two types of policies in place, a first type of policy may be automatically issued by insurer 40 upon payment of the premium if the risk allotted by insurer 40 or lender 12 falls within a predetermined range. If the risk value does not fall within a predetermined range, then an insurance policy could still be issued against that loan at a different premium with the approval of insurer 40.

For each loan, insurer 40 may quote a premium cost to the trust 34, with that premium being added to the cost of funds and passed on to borrower 20. The beneficiary of the insurance policy is the ABCP conduit 50, and in turn, the investors 60, who be paid the proceeds of the insurance upon the default of any loan.

Administration of the loan after closing may be by the lender 12 or a third party servicer (not shown), if in fact lender 12 has subcontracted servicing of the loans to a third party. In either case, payments by the borrower 20 pass through the servicer (not shown), trust 34, ABCP conduit 50, and to the investors 60. If the borrower defaults, the reinsurer 14 provides a first loss position to ensure that the investors 60 are paid. That first loss position of the reinsurer 14 may only provide insurance to a predetermined amount, which may be the amount of the loan pool, or a lesser amount, as a matter of design choice. The insurer 40 will cover any losses not covered by the reinsurer 14. Premiums for the insurer 40 are paid by the trust 34, and for the reinsurer 14 by the insurer 40.

As noted, based on the present disclosure, the processes, analyses, and steps discussed herein may be implemented on one or more computers configured and operating in accordance with computer readable program code residing on a computer readable medium. The computer readable program code is adapted to be executed by one or more processors to implement the method of the lending institution funding a pool of loans with one or more insurers. In certain embodiments, the computer readable medium contains computer readable code programmed to receive data regarding requests of borrowers related to the pool of loans and storing the data in electronic memory, analyze the data to determine risk associated with the pool of loans having an aggregate amount of the pool of loans, store the data and results of the analysis into electronic memory, and access the data from electronic memory and to secure insurance for the loans from the insurers based on the data.

The risk associated with the pool of loans includes the risk of first loss and a risk of loss other than the risk of the first loss. The first loss is a percentage of the aggregate amount of the pool of loans. The lending institution assumes the risk of the first loss by providing a first loss financial guaranty to the insurers. The lender's computer may store data regarding the first loss and the financial guaranty and may also electronically provide certain data to the computer of an insurer having one or more computers, in accordance with computer readable program code.

With respect to securing insurance, the computer readable program code may be programmed to cause the lender's computer to receive data regarding insurers and transfer, via the lender's computer and communications link, data related to the borrower and/or the loan requests to a particular insurer's computer (e.g., the amount of risk, teens and conditions of the request or guaranty), which is capable of receiving the data. The lender's computer may also be programmed to generate an electronic insurance request and electronically send verification data as requested by the insurer via the insurer's computer. The computer readable program code may also configure the lender computer to receive data from the insurer and to store the data in electronic memory. The computer readable program code may also configure the lender's computer to update data in a database on the lender's computer once insurance for the loan is secured. The data that is updated may include, but is not limited to, the financial rating associated with the loan (which may be no rating), the rating of the insurer, the amount of the loan, the risk associated with the loan, duration of the loan etc. The computer readable program code may also include modules or routines to program the lender's computer to electronically transfer the loan and/or loan documents to the insurer's computer, electronically receive proceeds from the insurer's computer in return, electronically designate the proceeds for funding the loan, electronically transfer funds as part of the loan, store data regarding electronic transfers in an electronic database in memory in communication with the lender's computer and update the database on the lender's computer as required.

In certain embodiments, the aforementioned method is implemented on one or more computers of a lender connected to a network. The lender's computer is capable of electronically communicating with one or more computers of a borrower or multiple borrowers. The lender is provided with a computer that includes one or more processors connected to a network and configured in accordance with software modules to receive data regarding loan requests from a borrower's computer (e.g., the personal and financial information of the borrower) via the electronic network, analyze the data to determine the risk of making a loan to that borrower, and approve or deny the loan request depending on the risk. The loan request is designated as approved by the lender's computer where the risk associated with making the loans falls within a predetermined lender risk criteria and the loan is included into a pool of loans. The loan is also associated with a first rating or no rating. The lender's computer is additionally configured to store the data regarding the loan (e.g., the rating, the amount of the loan, the risks associated with the loan) and the results of the risk analysis into electronic memory and is capable of retrieving or updating the data as directed by the user.

The lending institution assumes the risk of first loss on the loan, which is a predetermined percentage of the aggregate amount of the pool of loans, and the lender's computer stores data regarding the risk of first loss in an electronic database on the lender's computer. The lender's computer may electronically send an insurance request to an insurer having one or more computers, the insurer having a second rating or an entity that that secures insurance for the loan from the insurer having a second rating. The second rating of the insurer is higher than the first rating associated with the loan; thus, the insurer's second, higher rating inures to the loans once the loans are insured. The ratings may be communicated electronically and stored in electronic databases. The lender, via the lender's computer, thus, transfers a risk of loss other than the first loss to the insurer's computer and secures proceeds based on the pool of loans and the insurer's second rating. The lender's computer electronically sends the insurer's computer (or a computer of any entity procuring insurance) data regarding the loans. The lender's computer also electronically transfers the loans and electronically receives proceeds from the insurer's computer in return via the electronic network. The proceeds are greater than that which the lending institution could secure due to the insurer's second rating being greater than the first rating or no rating originally associated with the loan. The lender's computer then stores or updates data regarding the loan (e.g., data regarding insurance, risk of first loss, risk of loss other than the first loss (e.g., second loss), the proceeds received, and the funds to be used to fund the loans) in the electronic database. The lender's computer may also electronically send the borrower's computer notice of changes or updates in data regarding the loan.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

1-13. (canceled)

14. A method of a lending institution funding a pool of loans with one or more insurers, the pool of loans having associated therewith a first rating or no rating, an aggregate amount and a first loss, the insurers having a second rating greater than the first rating, the method comprising:
the lending institution assuming risk of the first loss by providing a first loss financial guaranty, the first loss being a percentage of the aggregate amount of the pool of loans;
the lending institution transforming the pool of loans from having the first rating or no rating to having the second rating by transferring the loans to an entity that secures insurance for the loans from the insurers, and transferring a risk of loss other than the first loss to the insurers, the entity issuing a note based on the pool of loans and securing proceeds by issuing the note based on the pool of loans and the second rating, the proceeds in an amount greater than that which the lending institution could secure due to the second rating being greater than the first rating or no rating;
the lending institution receiving the proceeds based on issuing the note from the entity in return for transferring the loans to the entity; and
the lending institution funding the loans using the proceeds.

15. A method as recited by claim 14, wherein the lending institution comprises a lender and a reinsurer, and wherein the first loss financial guaranty is reinsurance provided by the reinsurer, and wherein the pool of loans is a pool of loans of the lender.

16. A method as recited by claim 14, wherein the lending institution comprises a lender and a reinsurer, and wherein the first loss financial guaranty is reinsurance provided by the reinsurer, and wherein the pool of loans is a pool of loans of a third party.

17. A method as recited by claim 14, wherein the entity comprises a bankruptcy-remote entity and a trust.

18. A computer memory product having computer readable program code embodied thereon, the computer readable program code adapted to be executed by one or more processors to implement a method of a lending institution funding a pool of loans with one or more insurers, the pool of loans having associated therewith a first rating or no rating and the insurers having a second rating greater than the first rating or no rating, the method comprising:
receiving data regarding requests of borrowers related to the pool of loans and storing the data in electronic memory;
analyzing the data to determine risk associated with the pool of loans having an aggregate amount of the pool of loans, the risk including a risk of a first loss and a risk of loss other than the risk of the first loss, the first loss being a percentage of the aggregate amount of the pool of loans, the lending institution assuming the risk of the first loss by providing a first loss financial guaranty to the insurers; and
accessing the data from electronic memory and, based on the data, the lending institution securing insurance for the loans from the insurers, thereby transforming the pool of loans from having the first rating or no rating to having the second rating and transferring the risk of loss other than the risk of first loss to the insurers, the lending institution receiving the proceeds from an entity in return for transferring the loans to the entity and funding the pool of loans based on the data and using the proceeds.

19. The computer memory product of claim 18, wherein the lending institution transfers the loans to an entity and the entity secures insurance for the loans from the insurers.

20. The computer memory product of claim 18, wherein the lending institution comprises a lender and a reinsurer, and wherein the first loss financial guaranty is reinsurance provided by the reinsurer, and wherein the pool of loans is a pool of loans of the lender.

21. The computer memory product of claim 18, wherein the lending institution comprises a lender and a reinsurer, and wherein the first loss financial guaranty is reinsurance provided by the reinsurer, and wherein the pool of loans is a pool of loans of a third party.

22. The computer memory product of claim 18, wherein the entity comprises a bankruptcy-remote entity and a trust.

23. The computer memory product of claim 18, wherein the entity issues a note based on the pool of loans and securing proceeds by issuing the note based on the pool of loans and the second rating, the proceeds in an amount greater than that which the lending institution could secure due to the second rating being greater than the first rating.

24. A computer-implemented method of a lending institution funding a pool of loans with one or more insurers, the pool of loans having associated therewith an aggregate amount and a first rating or no rating, the insurers having a second rating greater than the first rating, the method comprising:
providing a lender computer connected to an electronic network, the lender computer including one or more processors configured in accordance with software to:
receive via the electronic network data regarding loan requests of one or more borrowers, the data including data regarding personal and financial information of each borrower;
analyze the data regarding each of the loan requests of the one or more borrowers to determine a risk associated with making a loan to each borrower;
approve for inclusion in the pool of loans, loans associated with the loan requests of the one or more borrowers where the risk associated with making the loans falls within lender risk criteria; and
retrieve from electronic memory data regarding the loans approved for inclusion in the pool of loans;
providing a first loss financial guaranty for the pool of loans, the lending institution assuming a risk of a first loss, the first loss being a percentage of the aggregate amount of the pool of loans;
transferring the pool of loans to an entity that secures insurance for the loans from the insurers, thereby transferring a risk of loss other than the risk of first loss to the insurers and securing proceeds based on the pool of loans and the second rating, the proceeds in an amount greater than that which the lending institution could secure due to the second rating being greater than the first rating or no rating;
receiving the proceeds in response to transferring the pool of loans to the entity; and
the lending institution causing the pool of loans to be funded based on the data and using the proceeds.

25. The computer-implemented method of claim 24, wherein the lending institution comprises a lender and a reinsurer, and wherein the first loss financial guaranty is reinsurance provided by the reinsurer, and wherein the pool of loans is a pool of loans of the lender.

26. The computer-implemented method of claim 24, wherein the lending institution comprises a lender and a reinsurer, and wherein the first loss financial guaranty is reinsurance provided by the reinsurer, and wherein the pool of loans is a pool of loans of a third party.

27. The computer-implemented method of claim 24, wherein the entity comprises a bankruptcy-remote entity and a trust.

28. The computer-implemented method of claim 24, wherein the entity issues a note based on the pool of loans and securing proceeds by issuing the note based on the pool of loans and the second rating, the proceeds in an amount greater than that which the lending institution could secure due to the second rating being greater than the first rating.
